(19) United States
(12) Patent Application Publication
(10) Pub. No.: US 2026/0063251 A1
(43) Pub. Date: Mar. 5, 2026

(54) HIGH PRESSURE TANK SYSTEM AND MOVING BODY

(71) Applicant: HONDA MOTOR CO., LTD., TOKYO (JP)

(72) Inventor: Satoru KAWASE, WAKO-SHI (JP)

(21) Appl. No.: 19/312,923

(22) Filed: Aug. 28, 2025

(30) Foreign Application Priority Data
Sep. 3, 2024 (JP) 2024-151633

(51) Int. Cl. F17C 13/00; B60K 15/03

(52) U.S. Cl. CPC F17C 13/002; B60K 15/03006; B60K 2015/03144; F17C 2205/0142; F17C 2221/012; F17C 2270/0168; F17C 2270/0184

(57) ABSTRACT

A high pressure tank system includes a group of high pressure tanks including a plurality of cylindrically-shaped high pressure tanks which are filled with a fuel gas, an accommodation unit configured to accommodate the group of high pressure tanks, and a discharge pipe through which a discharged gas that is guided from the motive power source flows. The axis line of each of the plurality of high pressure tanks extends in a first direction that is directed along a horizontal direction. The plurality of high pressure tanks are arranged in a second direction that is perpendicular to the first direction and directed along the horizontal direction. The discharge pipe is disposed between one pair of high pressure tanks that are adjacent to each other among the plurality of high pressure tanks, and the discharge pipe extends along the first direction.

### CROSS-REFERENCE TO RELATED APPLICATIONS

This application is based upon and claims the benefit of priority from Japanese Patent Application No. 2024-151633 filed on Sep. 3, 2024, the contents of which are incorporated herein by reference.

### BACKGROUND OF THE INVENTION

### Field of the Invention

The present disclosure relates to a high pressure tank system and a moving body.

### Description of the Related Art

In recent years, in order to make it possible for more people to ensure access to affordable, reliable, sustainable, and advanced energy, research and development have been conducted in relation to a high pressure tank system and a moving body that contribute to energy efficiency.

In JP 7067241 B2, a fuel cell vehicle (a moving body) is disclosed which is equipped with a high pressure tank system. The high pressure tank system includes a plurality of high pressure tanks which are filled with a hydrogen gas (a fuel gas) that is supplied to a fuel cell stack (a motive power source). An axis direction of each of the high pressure tanks extends in a first direction that is directed along a horizontal direction. The plurality of high pressure tanks are arranged in a second direction that is perpendicular to the first direction and directed along the horizontal direction.

### SUMMARY OF THE INVENTION

There is a long-awaited need for an improved high pressure tank system and an improved moving body.

The present invention has the object of satisfying the aforementioned need.

A first aspect of the present disclosure is characterized by a high pressure tank system, including a group of high pressure tanks including a plurality of high pressure tanks each having a cylindrical shape, the high pressure tanks being configured to be filled with a fuel gas that is supplied to a motive power source; an accommodation unit configured to accommodate the group of high pressure tanks; and a discharge pipe through which a discharged gas that is guided from the motive power source flows, wherein an axis line of each of the plurality of high pressure tanks extends in a first direction that is directed along a horizontal direction, the plurality of high pressure tanks are arranged in a second direction that is perpendicular to the first direction and directed along the horizontal direction, and the discharge pipe is disposed between one pair of high pressure tanks that are adjacent to each other among the plurality of high pressure tanks, and the discharge pipe extends along the first direction.

A second aspect of the disclosure is a moving body including the high pressure tank system according to the first aspect and the motive power source.

According to the present disclosure, a more satisfactory high pressure tank system and a more satisfactory moving body can be provided.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram showing a moving body equipped with a high pressure tank system;

FIG. 2 is a schematic cross-sectional view taken along line II-II of FIG. 1.

FIG. 3 is a schematic diagram of a high pressure tank system according to a first exemplary modification;

FIG. 4 is a schematic diagram of a high pressure tank system according to a second exemplary modification;

FIG. 5 is a schematic cross-sectional view taken along line V-V in FIG. 4.

### DETAILED DESCRIPTION OF THE INVENTION

In the case that a fuel gas is supplied from the high pressure tanks to the motive power source, the temperature of the fuel gas decreases due to adiabatic expansion of the fuel gas. When a low temperature fuel gas is supplied to the motive power source, it may have an adverse influence on the durability of seals in auxiliary components or the like. Further, the above-mentioned JP 7067241 B2 does not disclose a discharge pipe to which discharged gas of the fuel cell stack is guided. According to the present disclosure, it is possible to provide a high pressure tank system and a moving body which can prevent the low temperature fuel gas from being supplied to the motive power source and which can be reduced in size.

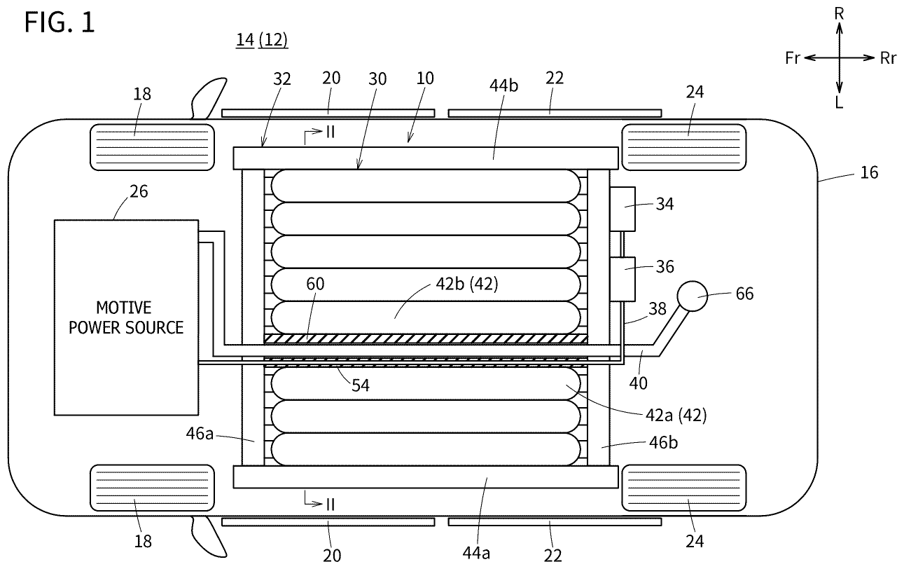

FIG. 1 is a schematic diagram showing a moving body 12 equipped with a high pressure tank system 10. As shown in FIG. 1, in the present embodiment, the moving body 12 is a vehicle 14 such as a fuel cell vehicle or the like. The moving body 12 is an object that possesses mobility, and is not necessarily limited to being the vehicle 14. The moving body 12 may be, for example, an aircraft such as an electric vertical takeoff and landing aircraft (eVTOL), a drone, or the like. Further, the high pressure tank system 10 is not necessarily limited to being mounted on the moving body 12. The high pressure tank system 10 may also be applied to a stationary fuel cell system.

In the present embodiment, in the vehicle 14 shown in FIG. 1, the “Fr direction” may be referred to as a “frontward direction”, the “Rr direction” may be referred to as a “rearward direction”, the “L direction” may be referred to as a “leftward direction”, and the “R direction” may be referred to as a “rightward direction”.

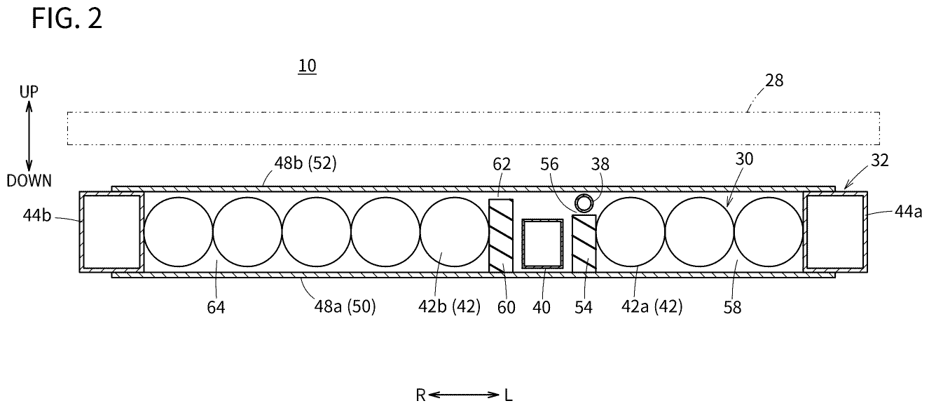

The vehicle 14 comprises a vehicle body 16, a pair of front wheels 18, a pair of front doors 20, a pair of rear doors 22, a pair of rear wheels 24, a motive power source 26, and the high pressure tank system 10. The vehicle body 16 includes a floor panel 28 (refer to FIG. 2).

The motive power source 26 is disposed in a front box (a motor room) that is disposed frontward (in the Fr direction) of the floor panel 28. The motive power source 26 is positioned between the pair of front wheels 18. The motive power source 26 is a motive power device (a power unit) that generates motive power such as electrical power or the like. The motive power source 26 includes a fuel cell that generates electricity by means of an electrochemical reaction between a fuel gas and an oxygen-containing gas. The motive power source 26 may include, for example, a hydrogen engine that is powered by a combustion reaction of the hydrogen gas.

The high pressure tank system 10 includes the group of high pressure tanks 30, an accommodation unit 32, an opening/closing valve 34, a pressure reducing valve 36, a supply pipe 38, and a discharge pipe 40. The group of high pressure tanks 30 includes a plurality of high pressure tanks 42. Each of the high pressure tanks 42 is filled with the fuel gas that is supplied to the motive power source 26. Specifically, each of the high pressure tanks 42 can be filled with the fuel gas at a pressure, for example, on the order of 70 MPa. As the fuel gas that is filled into the high pressure tanks 42, there may be cited, for example, a hydrogen gas. The fuel gas is not necessarily limited to being a hydrogen gas. The motive power source 26 is positioned between a front end of the vehicle 14 and the group of high pressure tanks 30.

The high pressure tanks 42 are each formed in a cylindrical shape. The high pressure tanks 42 are formed, for example, by winding a band-shaped fiber bundle impregnated with a resin around the outer surface of a non-illustrated cylindrically shaped liner. An axis line of each of the plurality of high pressure tanks 42 extends in a first direction (a frontward/rearward direction of the vehicle 14) that is directed along the horizontal direction. The plurality of high pressure tanks 42 are arranged in a second direction (a widthwise direction of the vehicle 14) which is perpendicular to the first direction and directed along the horizontal direction. The group of high pressure tanks 30 is disposed downwardly of the floor panel 28 (refer to FIG. 2).

FIG. 2 is a schematic cross-sectional view taken along line II-II of FIG. 1. As shown in FIG. 1 and FIG. 2, the accommodation unit 32 serves to accommodate the group of high pressure tanks 30. The accommodation unit 32 serves to protect the group of high pressure tanks 30 at the time of a collision of the vehicle 14. The accommodation unit 32 seals the group of high pressure tanks 30. Moreover, it should be noted that the accommodation unit 32 need not necessarily seal the group of high pressure tanks 30. More specifically, an accommodation space of the accommodation unit 32 may be placed in communication with the exterior of the accommodation unit 32. The accommodation unit 32 is mounted to the vehicle body 16.

The accommodation unit 32 includes a pair of side wall portions 44a and 44b, a pair of end wall portions 46a and 46b, and a pair of cover members 48a and 48b. The pair of side wall portions 44a and 44b cover at least a portion of the group of high pressure tanks 30 from the second direction (the direction in which the plurality of high pressure tanks 42 are arranged alongside one another). Stated otherwise, the side wall portion 44a covers at least a portion of the group of high pressure tanks 30 from the left direction (the L direction). The side wall portion 44b covers at least a portion of the group of high pressure tanks 30 from the right direction (the R direction). Each of the side wall portions 44a and 44b extends along the axial direction of the high pressure tanks 42 (the frontward/rearward direction of the vehicle 14). Each of the side wall portions 44a and 44b is formed in a hollow shape. In accordance with this feature, a collision energy at the time when the vehicle 14 collides can be suitably absorbed by the side wall portions 44a and 44b. The side wall portions 44a and 44b may be formed to be solid.

As shown in FIG. 1, the end wall portion 46a covers at least a portion of the group of high pressure tanks 30 from the frontward (the Fr direction). The end wall portion 46a mutually connects, to each other, end parts (end parts in the Fr direction) of the pair of side wall portions 44a and 44b. The end wall portion 46a supports one end part (end portion in the Fr direction) of each of the high pressure tanks 42. The end wall portion 46b covers at least a portion of the group of high pressure tanks 30 from the rear (the Rr direction). The end wall portion 46b mutually connects, to each other, the other end parts (end parts in the Rr direction) of the pair of side wall portions 44a and 44b. The end wall portion 46b supports the other end part (end portion in the Rr direction) of each of the high pressure tanks 42.

As shown in FIG. 2, the cover member 48a is a lower wall portion 50 that covers at least a portion of the group of high pressure tanks 30 from below. The cover member 48b is an upper wall portion 52 that covers at least a portion of the group of high pressure tanks 30 from above.

As shown in FIG. 1, the opening/closing valve 34 is mounted on the end wall portion 46b. The opening/closing valve 34 is a main stop valve in order to stop the supply of the fuel gas from the group of high pressure tanks 30 to the supply pipe 38. The pressure reducing valve 36 serves to reduce the pressure of the fuel gas that is guided from the opening/closing valve 34 to a predetermined pressure. The supply pipe 38 supplies the fuel gas that is drawn out from the group of high pressure tanks 30 to the motive power source 26. The supply pipe 38 is formed, for example, in a circular pipe shape (refer to FIG. 2). The supply pipe 38 is disposed in a manner so as to pass through the accommodation space of the accommodation unit 32. The supply pipe 38 penetrates the pair of end wall portions 46a and 46b. The size, the shape, and the like of the supply pipe 38 can be set appropriately.

The discharged gas which is guided from the motive power source 26 flows through the discharge pipe 40. Moisture (water) is contained within the discharged gas. According to the present embodiment, the fuel cells of the motive power source 26 discharge a fuel off-gas and an oxygen-containing off-gas. The fuel off-gas contains generated water that is generated during the generation of electricity. The motive power source 26 includes a gas-liquid separator which separates the fuel off-gas into a gas and a liquid and stores the liquid water that has been separated from the fuel off-gas. The motive power source 26, by using the fuel off-gas, discharges the liquid water that is stored in the gas-liquid separator into the discharge pipe 40. In this case, in order to dilute the fuel gas concentration (a hydrogen gas concentration) that is discharged from the vehicle 14, the motive power source 26 mixes the oxygen-containing off-gas or an oxygen-containing gas with the fuel off-gas. Therefore, the discharged gas containing the fuel off-gas and the liquid water flow through the discharge pipe 40. In many situations, the discharged gas is higher in temperature than the fuel gas with which the high pressure tanks 42 is filled.

The discharge pipe 40 extends rearward (i.e., in the Rr direction) from the motive power source 26. The discharge pipe 40 is disposed so as to pass through the accommodation space of the accommodation unit 32. The discharge pipe 40 is formed in a rectangular pipe shape, for example. The height of the discharge pipe 40 in the upward/downward direction is equal to or less than the outer diameter of each of the high pressure tanks 42. Thus, the discharge pipe 40 can be disposed in the accommodation space of the accommodation unit 32 without increasing the height of the accommodation unit 32. The size, the shape, and the like of the discharge pipe 40 can be set as appropriate. The discharge pipe 40 extends in the axis direction of the high pressure tanks 42. The discharge pipe 40 (exhaust pipe 40) extends parallel to the high pressure tanks 42.

The discharge pipe 40 is disposed between one pair of high pressure tanks 42 adjacent to each other among the plurality of high pressure tanks 42. Hereinafter, one of the pair of high pressure tanks 42 sandwiching the discharge pipe 40 is referred to as a “first high pressure tank 42a”, and the other of the pair of high pressure tanks 42 sandwiching the discharge pipe 40 is referred to as a “second high pressure tank 42b”. The discharge pipe 40 extends along the axis direction of the high pressure tanks 42 (the frontward/rearward direction of the vehicle 14).

As shown in FIG. 2, a first heat insulating member 54 is disposed between the first high pressure tank 42a and the discharge pipe 40. The first heat insulating member 54 prevents heat transfer from the discharge pipe 40 to the first high pressure tank 42a. This can prevent the first high pressure tank 42a disposed near the discharge pipe 40 from being excessively heated by heat of the discharged gas flowing through the discharge pipe 40. The first heat insulating member 54 is made of, for example, glass wool, expanded polystyrene, a heat shield plate, or the like. The heat shield plate may be, for example, an iron plate.

The first heat insulating member 54 extends along the discharge pipe 40. The first heat insulating member 54 extends from the end wall portion 46a to the end wall portion 46b (see FIG. 1). The first heat insulating member 54 is in contact with or close to the lower wall portion 50. A first gap 56 is provided between the first heat insulating member 54 and the upper wall portion 52. The supply pipe 38 is disposed in the first gap 56. At least a portion of the supply pipe 38 extends along the discharge pipe 40. Specifically, in the accommodation space of the accommodation unit 32, the supply pipe 38 extends along the discharge pipe 40. The outer diameter of the supply pipe 38 is smaller than the outer diameter of the high pressure tank 42. The outer diameter of the supply pipe 38 is smaller than the height of the discharge pipe 40. A plurality of (for example, three) high pressure tanks 42 are disposed in a first space 58 between the first heat insulating member 54 and the side wall portion 44a.

A second heat insulating member 60 is disposed between the second high pressure tank 42b and the discharge pipe 40. The second heat insulating member 60 prevents heat transfer from the discharge pipe 40 to the second high pressure tank 42b. This can prevent the second high pressure tank 42b disposed near the discharge pipe 40 from being excessively heated by heat of the discharged gas flowing through the discharge pipe 40. The second heat insulating member 60 can be made of the same material as the first heat insulating member 54.

The second heat insulating member 60 extends along the discharge pipe 40. The second heat insulating member 60 extends from the end wall portion 46a to the end wall portion 46b (see FIG. 1). The second heat insulating member 60 is in contact with or close to the lower wall portion 50. A second gap 62 is formed between the second heat insulating member 60 and the upper wall portion 52. A plurality of (for example, five) high pressure tanks 42 are disposed in a second space 64 between the second heat insulating member 60 and the side wall portion 44b. The number of the high pressure tanks 42 disposed in the second space 64 is larger than the number of the high pressure tanks 42 disposed in the first space 58. In this case, for example, the thickness of the first heat insulating member 54 (the dimension along the arrangement direction of the plurality of high pressure tanks 42) may be made larger than the thickness of the second heat insulating member 60. With this configuration, the heat insulating performance of the first heat insulating member 54 is higher than the heat insulating performance of the second heat insulating member 60. Thus, heat of the discharged gas flowing through the discharge pipe 40 is more easily transferred to the second space 64 than to the first space 58. Therefore, the high pressure tanks 42 disposed in the first space 58 and the high pressure tanks 42 disposed in the second space 64 can be heated as evenly as possible. Alternatively, the constituent material of the first heat insulating member 54 and the constituent material of the second heat insulating member 60 may be appropriately selected in order that the heat insulating performance of the first heat insulating member 54 may be higher than the heat insulating performance of the second heat insulating member 60.

A gap through which air heated by the discharge pipe 40 can be guided to the first space 58 may be provided between the first heat insulating member 54 and the lower wall portion 50. A gap through which air heated by the discharge pipe 40 can be guided to the second space 64 may be provided between the second heat insulating member 60 and the lower wall portion 50. The number of the high pressure tanks 42 disposed in each of the first space 58 and the second space 64 can be set as appropriate.

One end portion (end portion in the Fr direction) of the discharge pipe 40 is connected to the motive power source 26. A discharge outlet port 66 is provided at the other end portion (end portion in the Rr direction) of the discharge pipe 40. The discharge outlet port 66 discharges the discharged gas and the liquid water that have flowed through the discharge pipe 40 to the outside. The discharge outlet port 66 faces downward, for example. The discharge outlet port 66 is located rearward of the pair of rear doors 22. The discharge outlet port 66 is located between the pair of rear wheels 24. This can prevent the liquid water blown out from the discharge outlet port 66 from splashing around the vehicle 14. The position of the discharge outlet port 66 can be set as appropriate.

In the accommodation space of the accommodation unit 32, the supply pipe 38 is located above the discharge pipe 40. In the accommodation space of the accommodation unit 32, the discharge pipe 40 and the supply pipe 38 are located adjacent to each other.

Next, a description will be given concerning the operation of the vehicle 14. To drive the vehicle 14, the fuel gas that is filled in the high pressure tanks 42 is supplied via the supply pipe 38 to the fuel cells of the motive power source 26. Further, the oxygen-containing gas is supplied to the fuel cells of the motive power source 26. In the fuel cells, the hydrogen gas and the oxygen-containing gas are consumed by way of an electrochemical reaction. As a result, electrical power is generated. The motive power source 26 discharges the discharged gas containing moisture (liquid water) that has been generated during the generation of electricity into the discharge pipe 40. The discharged gas guided to the discharge pipe 40 together with the liquid water is discharged from the discharge outlet port 66 to the outside of the vehicle 14. Since the discharge outlet port 66 is located between the pair of rear wheels 24, when the occupant gets in the vehicle or gets out of the vehicle through the rear doors 22, it is possible to prevent the water, which is contained within the discharged gas that is discharged from the discharge outlet port 66, from splashing on the occupant. The position of the discharge outlet port 66 can be set as appropriate. The discharge outlet port 66 may be located between the pair of front wheels 18. The discharge outlet port 66 may be positioned at a position rearward of the front wheels 18 and frontward of the rear wheels 24 in the frontward/rearward direction (the lengthwise direction) of the vehicle 14. In this case, the discharge outlet port 66 may be positioned (in an inner space) between the pair of rear wheels 24 or (in an inner space) between the pair of front wheels 18, in the vehicle widthwise direction.

When the fuel gas that is filled in the high pressure tanks 42 is supplied to the motive power source 26, since the fuel gas inside the high pressure tanks 42 undergoes adiabatic expansion, the temperature of the fuel gas decreases. In particular, in the case that the motive power source 26 is operated over a long time period and at a high output, the temperature of the fuel gas is likely to decrease. Since such a decrease in the temperature of the fuel gas can adversely influence the durability of seals in auxiliary components or the like, this must be taken into consideration when designing is carried out.

The discharged gas which is comparatively high in temperature flows through the discharge pipe 40. Since the first heat insulating member 54 is disposed between the discharge pipe 40 and the first high pressure tank 42a, transfer of heat from the discharge pipe 40 to the first high pressure tank 42a is suppressed by the first heat insulating member 54. As a result, the first high pressure tank 42a can be prevented from being excessively heated by heat of the discharged gas flowing through the discharge pipe 40. Further, since the second heat insulating member 60 is disposed between the discharge pipe 40 and the second high pressure tank 42b, heat transfer from the discharge pipe 40 to the second high pressure tank 42b is suppressed by the second heat insulating member 60. As a result, the second high pressure tank 42b can be prevented from being excessively heated by heat of the discharged gas flowing through the discharge pipe 40.

Further, since the lower wall portion 50 is located below the discharge pipe 40, it is possible to prevent the heat of the discharged gas flowing through the discharge pipe 40 from escaping from the lower side of the accommodation unit 32. Further, since the upper wall portion 52 is located above the discharge pipe 40, it is possible to prevent the heat of the discharged gas flowing through the discharge pipe 40 from escaping from the upper side of the accommodation unit 32.

Air heated by the discharge pipe 40 is guided to the first gap 56 and the second gap 62. The relatively high-temperature air guided to the first gap 56 heats the supply pipe 38. This makes it possible to heat the fuel gas flowing through the supply pipe 38. The air that has flowed through the first gap 56 is guided to the first space 58. Therefore, the relatively high-temperature air guided to the first space 58 heats the plurality of high pressure tanks 42 disposed in the first space 58. This enables the fuel gas filled in the high pressure tanks 42 disposed in the first space 58 to be heated.

The relatively high-temperature air guided to the second gap 62 is guided to the second space 64. Therefore, the relatively high-temperature air guided to the second space 64 heats the plurality of high pressure tanks 42 disposed in the second space 64. This enables the fuel gas filled in the high pressure tanks 42 disposed in the second space 64 to be heated.

In the present embodiment, the discharge pipe 40 is disposed between a pair of high pressure tanks 42 and extends along the first direction. Therefore, the high pressure tanks 42 can be heated by the relatively high-temperature discharged gas flowing through the discharge pipe 40. In accordance with this feature, it is possible to prevent the low-temperature fuel gas from being supplied to the motive power source 26. Further, the high pressure tank system 10 can be made smaller in size than in a case where the discharge pipe 40 is disposed in the upward and downward direction with respect to the group of high pressure tanks 30.

### First Exemplary Modification

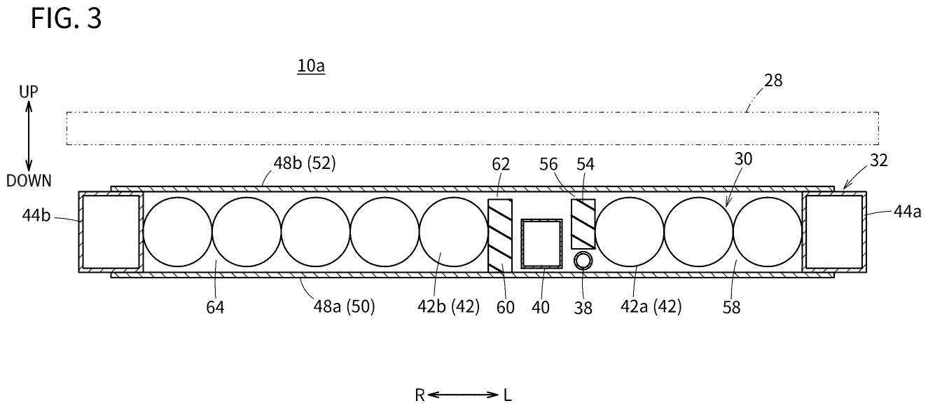

Next, a description will be given concerning a high pressure tank system 10a according to a first exemplary modification. FIG. 3 is a schematic diagram of the high pressure tank system 10a according to the first exemplary modification. Among the constituent components of the high pressure tank system 10a according to the first exemplary modification, the same constituent components as those of the above-described high pressure tank system 10 are designated by the same reference numerals, and detailed description of such features will be omitted. The same applies to a high pressure tank system 10b according to a second exemplary modification described later.

As shown in FIG. 3, in the high pressure tank system 10a, the supply pipe 38 is disposed below the first heat insulating member 54 and between the first heat insulating member 54 and the lower wall portion 50. In such a configuration as well, the same advantageous effects as those of the above-described high pressure tank system 10 are realized.

### Second Exemplary Modification

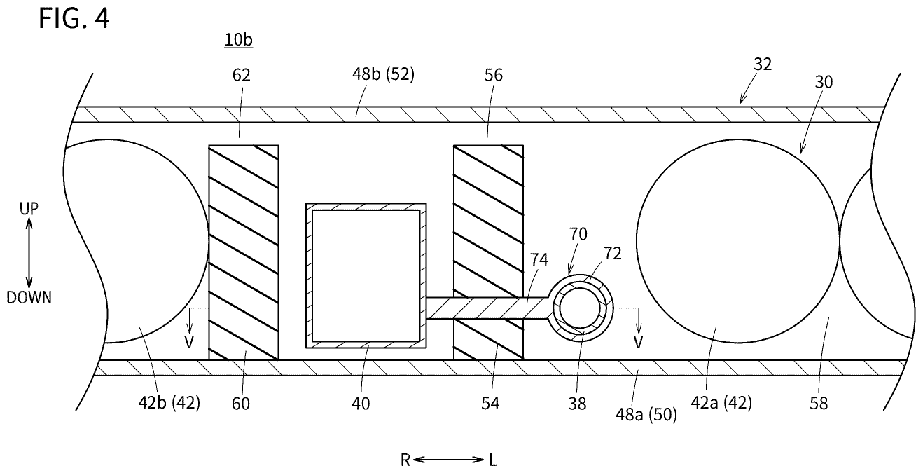

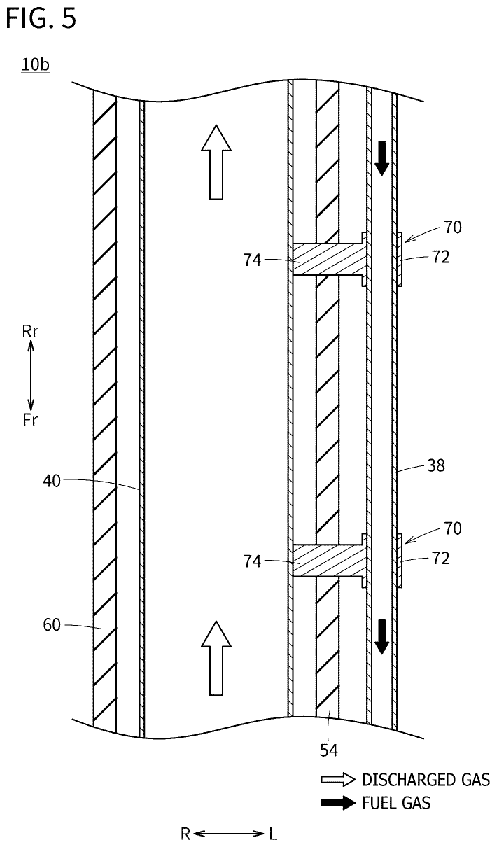

Next, a description will be given concerning a high pressure tank system 10b according to a second exemplary modification. FIG. 4 is a schematic diagram of the high pressure tank system 10b according to the second exemplary modification. FIG. 5 is a schematic cross-sectional view taken along line V-V in FIG. 4.

As shown in FIGS. 4 and 5, in the high pressure tank system 10b, the supply pipe 38 is disposed in the first space 58. The first heat insulating member 54 is disposed between the supply pipe 38 and the discharge pipe 40. The high pressure tank system 10b further includes a plurality of heat-transfer members 70 that connect the discharge pipe 40 and the supply pipe 38. The heat-transfer members 70 transfer heat of the discharge pipe 40 to the supply pipe 38. The plurality of heat-transfer members 70 are disposed at intervals in the first direction (the axis direction of the high pressure tanks 42). The heat-transfer members 70 are made of a material having a higher thermal conductivity than air. The heat-transfer members 70 are made of, for example, a metal material.

Each of the heat-transfer members 70 includes a first heat-transfer portion 72 and a second heat-transfer portion 74. The first heat-transfer portion 72 is formed in an annular shape (circular ring shape). The inner circumferential surface of the first heat-transfer portion 72 is in contact with the outer circumferential surface of the supply pipe 38. The second heat-transfer portion 74 connects the first heat-transfer portion 72 and the discharge pipe 40. The second heat-transfer portion 74 is in contact with the outer peripheral surface of the discharge pipe 40.

According to the present exemplary modification, the heat of the discharged gas flowing through the discharge pipe 40 can be transferred to the supply pipe 38 via the heat-transfer member 70. This makes it possible to efficiently heat the fuel gas flowing through the supply pipe 38.

In relation to the above-described embodiments, the following Supplementary Notes are further disclosed.

### Supplementary Note 1

The high pressure tank system (10, 10a, 10b) of the present disclosure includes the group of high pressure tanks (30) including the plurality of high pressure tanks (42) each having a cylindrical shape, the high pressure tanks being configured to be filled with fuel gas that is supplied to the motive power source (26); the accommodation unit (32) configured to accommodate the group of high pressure tanks; and the discharge pipe (40) through which the discharged gas that is guided from the motive power source flows. The axis line of each of the plurality of high pressure tanks extends in the first direction that is directed along the horizontal direction. The plurality of high pressure tanks are arranged in the second direction that is perpendicular to the first direction and directed along the horizontal direction. The discharge pipe is disposed between one pair of high pressure tanks (42a, 42b) that are adjacent to each other among the plurality of high pressure tanks, and the discharge pipe extends along the first direction.

According to such a configuration, the discharge pipe is disposed between a pair of high-pressure tanks and extends along the first direction. Therefore, the high pressure tanks can be heated by the relatively high-temperature discharged gas flowing through the discharge pipe. This feature can prevent the low temperature fuel gas from being supplied to the motive power source. Further, the high pressure tank system can be made smaller in size than in a case where the discharge pipe is disposed in the upward and downward direction with respect to the group of high pressure tanks.

### Supplementary Note 2

In the high pressure tank system according to Supplementary Note 1, the first heat insulating member (54) may be disposed between one of the one pair of high pressure tanks and the discharge pipe.

According to such a configuration, the first heat insulating member can prevent overheating of one of the pair of high pressure tanks that are adjacent to the discharge pipe.

### Supplementary Note 3

In the high pressure tank system according to Supplementary 2, the second heat insulating member (60) may be disposed between the other of the one pair of high pressure tanks and the discharge pipe.

According to such a configuration, the second heat insulating member can prevent overheating of the other of the pair of high pressure tanks that are adjacent to the discharge pipe.

### Supplementary Note 4

The high pressure tank system according to any one of Supplementary Notes 1 to 3 may further include the supply pipe (38) configured to guide the fuel gas from the group of high pressure tanks to the motive power source, wherein the supply pipe may be disposed in the accommodation space of the accommodation unit.

According to such a configuration, the accommodation space of the accommodation unit is heated by heat of the discharged gas flowing through the discharge pipe, and thus the fuel gas flowing through the supply pipe disposed in the accommodation space of the accommodation unit can be heated.

### Supplementary Note 5

In the high pressure tank system according to Supplementary Note 4, at least a portion of the supply pipe may be disposed along the discharge pipe.

According to such a configuration, the heat of the discharged gas flowing through the discharge pipe can be efficiently transferred to the supply pipe.

### Supplementary Note 6

In the high pressure tank system according to Supplementary Note 5, the flow direction of the fuel gas flowing through the supply pipe may be opposite to the flow direction of the discharged gas flowing through the discharge pipe.

With this configuration, since a counterflow heat exchange takes place, the fuel gas that flows through the supply pipe can be heated efficiently.

### Supplementary Note 7

In the high pressure tank system according to Supplementary Note 6, the supply pipe may extend from the opposite side of the group of high pressure tanks from the motive power source, via the accommodation space of the accommodation unit, to the motive power source.

According to such a configuration, the fuel gas flowing through the supply pipe can be heated while the high pressure tank system has a simple configuration.

### Supplementary Note 8

The high pressure tank system according to any one of Supplementary Notes 4 to 7 may further include the heat-transfer member (70) that connects the discharge pipe and the supply pipe.

According to this configuration, the heat of the discharged gas flowing through the discharge pipe can be efficiently transferred to the supply pipe via the heat-transfer member.

### Supplementary Note 9

The high pressure tank system according to Supplementary Note 2 or 3 may further include the supply pipe configured to guide the fuel gas from the plurality of high pressure tanks to the motive power source, wherein the accommodation unit may include the cover member (48a, 48b) configured to cover at least a portion of the group of high pressure tanks from above or from below, and the supply pipe may be disposed between the cover member and the first heat insulating member.

According to such a configuration, when the cover member covers at least a portion of the group of high pressure tanks from above, the cover member can prevent the heat of the discharged gas flowing through the discharge pipe from escaping from the upper side of the accommodation unit. Further, when the cover member covers at least a portion of the group of high pressure tanks from below, the cover member can prevent the heat of the discharged gas flowing through the discharge pipe from escaping from the lower side of the accommodation unit. This makes it possible to heat the fuel gas flowing through the supply pipe more efficiently.

### Supplementary Note 10

The high pressure tank system according to Supplementary Note 2 or 3 may further include the supply pipe configured to guide the fuel gas from the group of high pressure tanks to the motive power source, wherein the accommodation unit may include the lower wall portion (50) configured to cover at least a portion of the group of high pressure tanks from below, and the supply pipe may be disposed above the discharge pipe.

According to such a configuration, the lower wall portion can prevent the heat of the discharged gas flowing through the discharge pipe from escaping from the lower side of the accommodation unit. Further, since the supply pipe is disposed above the discharge pipe, air heated by the discharge pipe is easily guided to the supply pipe. Therefore, the fuel gas flowing through the supply pipe can be heated more efficiently.

### Supplementary Note 11

The high pressure tank system according to Supplementary Note 2 or 3 may further include the supply pipe configured to guide the fuel gas from the group of high pressure tanks to the motive power source, wherein the accommodation unit may include the upper wall portion (52) configured to cover at least a portion of the group of high pressure tanks from above, and the supply pipe may be disposed above the discharge pipe.

According to such a configuration, the upper wall portion can prevent the heat of the discharged gas flowing through the discharge pipe from escaping from the upper side of the accommodation unit. Further, since the supply pipe is disposed above the discharge pipe, air heated by the discharge pipe is easily guided to the supply pipe. Therefore, the fuel gas flowing through the supply pipe can be heated more efficiently.

### Supplementary Note 12

In the high pressure tank system according to any one of Supplementary Notes 1 to 11, the height of the discharge pipe in the upward/downward direction may be equal to or less than the outer diameter of each of the high pressure tanks.

According to such a configuration, the discharge pipe can be accommodated inside the accommodation unit without increasing the height of the accommodation unit. This enables the high pressure tank system to be miniaturized.

### Supplementary Note 13

In the high pressure tank system according to any one of Supplementary Notes 1 to 12, the accommodation unit may include the lower wall portion that covers at least a portion of the group of high pressure tanks from below, and the upper wall portion that covers at least a portion of the group of high pressure tanks from above.

According to such a configuration, the lower wall portion and the upper wall portion can prevent the heat of the discharged gas flowing through the discharge pipe from escaping from the lower side and the upper side of the accommodation unit.

### Supplementary Note 14

In the high pressure tank system according to any one of Supplementary Notes 1 to 13, the motive power source may include a fuel cell or a hydrogen engine, and the fuel gas may be hydrogen gas.

According to such a configuration, the hydrogen gas can be heated by the discharged gas of the fuel cell.

### Supplementary Note 15

The moving body (12) of the present disclosure includes the high pressure tank system according to any one of Supplementary Notes 1 to 14, and the motive power source.

According to such a configuration, it is possible to obtain a moving object that achieves the advantageous effects described in any one of Supplementary Notes 1 to 14.

### Supplementary Note 16

In the moving body according to Supplementary Note 15, the moving body may be a vehicle (14), and the group of high pressure tanks may be disposed below the floor panel (28).

According to such a configuration, a vehicle in which the group of high pressure tanks is disposed below the floor panel can be obtained.

### Supplementary Note 17

In the moving body according to Supplementary Note 15 or 16, the moving body may be a vehicle, the motive power source may be positioned between the front end of the vehicle and the group of high pressure tanks, the first direction may be the frontward/rearward direction of the vehicle, and the second direction is the widthwise direction of the vehicle.

According to such a configuration, the group of high pressure tanks can be arranged compactly in the vehicle.

Although the present disclosure has been described in detail, the present disclosure is not necessarily limited to each of the aforementioned embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same applies also to a case that numerical values or mathematical equations are used in the description of the aforementioned embodiments.

In the above-described embodiments, the configuration in which the discharge pipe is disposed between the high pressure tanks adjacent to each other has been disclosed. According to this configuration, the high pressure tanks can be efficiently heated, and the high pressure tank system can be downsized. In the high pressure tank system, the discharge pipe may be disposed between the high pressure tank located at the endmost position among the plurality of high pressure tanks and the side wall portion of the accommodation unit. Even in this case, the high pressure tanks can be heated, and the high pressure tank system can be downsized.

1. A high pressure tank system, comprising:
a group of high pressure tanks comprising a plurality of high pressure tanks each having a cylindrical shape, the high pressure tanks being configured to be filled with a fuel gas that is supplied to a motive power source;
an accommodation unit configured to accommodate the group of high pressure tanks; and
a discharge pipe through which a discharged gas that is guided from the motive power source flows,
wherein
an axis line of each of the plurality of high pressure tanks extends in a first direction that is directed along a horizontal direction,
the plurality of high pressure tanks are arranged in a second direction that is perpendicular to the first direction and directed along the horizontal direction, and
the discharge pipe is disposed between one pair of high pressure tanks that are adjacent to each other among the plurality of high pressure tanks, and the discharge pipe extends along the first direction.

2. The high pressure tank system according to claim 1, wherein
a first heat insulating member is disposed between one of the one pair of high pressure tanks and the discharge pipe.

3. The high pressure tank system according to claim 2, wherein
a second heat insulating member is disposed between another of the one pair of high pressure tanks and the discharge pipe.

4. The high pressure tank system according to claim 1, further comprising a supply pipe configured to guide the fuel gas from the group of high pressure tanks to the motive power source,
wherein the supply pipe is disposed in an accommodation space of the accommodation unit.

5. The high pressure tank system according to claim 4, wherein
at least a portion of the supply pipe is disposed along the discharge pipe.

6. The high pressure tank system according to claim 5, wherein
a flow direction of the fuel gas flowing through the supply pipe is opposite to a flow direction of the discharged gas flowing through the discharge pipe.

7. The high pressure tank system according to claim 6, wherein
the supply pipe extends from an opposite side of the group of high pressure tanks from the motive power source, via the accommodation space of the accommodation unit, to the motive power source.

8. The high pressure tank system according to claim 4, further comprising a heat-transfer member that connects the discharge pipe and the supply pipe.

9. The high pressure tank system according to claim 2, further comprising a supply pipe configured to guide the fuel gas from the plurality of high pressure tanks to the motive power source,
wherein the accommodation unit includes a cover member configured to cover at least a portion of the group of high pressure tanks from above or from below, and
the supply pipe is disposed between the cover member and the first heat insulating member.

10. The high pressure tank system according to claim 2, further comprising a supply pipe configured to guide the fuel gas from the group of high pressure tanks to the motive power source,
wherein the accommodation unit includes a lower wall portion configured to cover at least a portion of the group of high pressure tanks from below, and
the supply pipe is disposed above the discharge pipe.

11. The high pressure tank system according to claim 2, further comprising a supply pipe configured to guide the fuel gas from the group of high pressure tanks to the motive power source,
wherein the accommodation unit includes an upper wall portion configured to cover at least a portion of the group of high pressure tanks from above, and
the supply pipe is disposed above the discharge pipe.

12. The high pressure tank system according to claim 1, wherein
a height of the discharge pipe in an upward/downward direction is equal to or less than an outer diameter of each of the high pressure tanks.

13. The high pressure tank system according to claim 1, wherein
the accommodation unit includes:
a lower wall portion configured to cover at least a portion of the group of high pressure tanks from below; and
an upper wall portion configured to cover at least a portion of the group of high pressure tanks from above.

14. The high pressure tank system according to claim 1, wherein
the motive power source comprises a fuel cell or a hydrogen engine, and
the fuel gas is a hydrogen gas.

15. A moving body comprising:
the high pressure tank system according to claim 1; and
the motive power source.

16. The moving body according to claim 15, wherein
the moving body is a vehicle, and
the group of high pressure tanks is disposed below a floor panel.

17. The moving body according to claim 15, wherein
the moving body is a vehicle,
the motive power source is positioned between a front end of the vehicle and the group of high pressure tanks,
the first direction is a frontward/rearward direction of the vehicle, and
the second direction is a widthwise direction of the vehicle.
